(19) United States
(12) Patent Application Publication
(10) Pub. No.: US 2014/0278672 A1
(43) Pub. Date: Sep. 18, 2014

(54) METHOD FOR ALERTING PEOPLE TO EVENTS

(71) Applicant: Yakov Z. Mermelstein, Spring Valley, NY (US)

(72) Inventor: Yakov Z. Mermelstein, Spring Valley, NY (US)

(21) Appl. No.: 13/804,649

(22) Filed: Mar. 14, 2013

(51) Int. Cl. G06Q 10/10

(52) U.S. Cl. CPC G06Q 10/1095
USPC 705/7.19

(57) ABSTRACT

Upon receipt of an electronic notice about an event, the recipient's electronic calendar is automatically updated so as to show the dates of the event. In particular, the method for alerting people to events includes: sending an electronic communication to a preselected group of people; and automatically inserting dates, times and locations of a subject matter of electronic communication on electronic calendars of recipients of the electronic communication.

### FIELD OF THE INVENTION

This invention relates to the electronics and communications industry and, more particularly, to a method for alerting people about something, like events.

### BACKGROUND OF THE INVENTION

With ever increasing frequency, people receive notices about various events. It could be a notice of a private sale at a department store, like Macy's. A Conference notice may be received. It could be an invitation to a party or some special business event. Whatever the event may be, the recipient of the notice needs to have some way to keep track of the event and to know when it will be held

Therefore, there is a need in the industry for a method to more efficiently alert people about events.

### SUMMARY OF THE INVENTION

These and other objects of the invention are achieved with a method for alerting people about notices. In particular, upon receipt of an electronic notice about an event or something else, the recipient's electronic calendar is automatically updated so as to show the dates of the event or whatever is the subject of the notice.

According to the Invention, the method for alerting people to events, comprises: sending an electronic communication to a preselected group of people; and, Automatically inserting dates, times and locations of a subject matter of the notice on electronic calendars of recipients of said electronic communication

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention

The invention will now be described in connection with certain preferred embodiments with reference to the following illustrative figures so that it may be more fully understood.

FIG. 1 is a flow chart, showing the process of the invention.

FIG. 2 is a flow chart, showing an additional feature of the process of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to the Invention, in its simplest, basic form, it involves, upon receipt of an electronic notice about an event, the recipient's electronic calendar being automatically updated so as to show the dates of the event.

It may be appreciated that the invention preferably refers to events, but it also contemplates notices about anything. The subject matter of the notice is what will be inserted on the electronic calendar, and most frequently it will refer to events.

In the preferred embodiment of the invention (FIG. 1), the method for alerting people to events comprises: sending an electronic communication to a preselected group of people; and automatically inserting dates, times and locations of a subject matter of said notice on electronic calendars of recipients of said electronic communication.

The subject matter of the notice may be anything, including, inter alia, a payment notice, an event notice, a coupon, merchandise return deadlines, warranty information, mortgage payments, credit card payments, and/or payments with due dates.

In the preferred embodiment, the electronic communication includes information about an event, and then the inserting step includes inserting dates, times and locations of the event on electronic calendars of recipients of said electronic communication

Calendaring software is software that minimally provides users with an electronic version of a calendar. Additionally, the software may provide an appointment book, address book, and/or contact list. These tools are an extension of many of the features provided by time management software such as desk accessory packages and computer office automation systems. Calendaring is a standard feature of many PDAs, EDAs, and smart phones.

The software may be a local package designed for individual use or may be a networked package that allows for the sharing of information between users.

The flow of the process is shown in FIG. 1 herein.

Some entity, typically a business, will want to alert people about some activity or event. A department store, like Macy's, may be having a private sale. An organization may be having a convention or conference. The herein invention contemplates a notice of any type of event (even a wedding) from any person or entity or business—either personal or professional or business related. In some cases the notice may be about a deadline of a warranty or a payment date for a utility or something else.

To notify people about the event or activity, some type of electronic notice is send to persons on a distribution list. Typically the communication will be by e mail. Organizations and businesses have electronic address lists. Often they can have thousands or even tens of thousands of persons on it. An e mail blast is generated and all the people on that distribution list receive an e mail about the event, including critical data, like day, time and location.

An Email Blast is an electronic mailing, sent all at once to a large mailing list. This is commonly used by marketers who want to send email advertisements or promotions to their list of customers. They can be a good way to advertise to customers or to quickly notify selected people about some activity or event.

E mail blasts are not new and they are well known.

The novel aspect of the invention concerns what happens when the E mail blast is received.

Upon receipt of the electronic notice, without active involvement of the recipient, the subject matter of the notice, such as, in the preferred embodiment, information about the event, is automatically entered onto his electronic calendar. In this manner, by glancing at his calendar, a person knows about an upcoming event or activity or other requirement, as it is on his calendar.

The main idea here is to have the calendar used and not take up a specific meeting time. What this means is that while the calendar shows the event, it shows it in a background type manner so that the person can still set up meetings, phone calls and other activities which overlap in time.

Therefore, the dates, times and locations of the event may be inserted on the electronic calendars of recipients in a manner which does not interfere with scheduling other activities.

A listing of the event on the electronic calendar may include the number of days left for the event. For example, if the event is a week long, on the 1^{st} daily listing it may say “6 days left”; on the 2^{nd} daily listing it may say “5 days left”; and, on the last daily listing it may say “last day.”

An additional feature is that recipients of the electronic communication can select a specific time and day to attend said event, and it is automatically entered on their electronic calendar. In particular, when the electronic communication is received, all the dates of the event are entered on the recipient's electronic calendar. The recipient can go one step farther if they desire to attend. It is possible for them in one step to open the calendar entry and mark the specific day and time they intend to attend. This works well when they are just attending and do not need to meet anyone.

In some cases, they may choose to respond to the electronic notice to set a specific meeting with a specific person.

According to an additional embodiment (FIG. 2), the method further includes recipients of the electronic communication being able to register for the event. This has several aspects to it.

Registration can be as simple as sending a return e mail to the event holder. On his electronic calendar, a person can click a registration icon, and a registration process is automatically accomplished. This can be based on extracting relevant information about the recipient from his personal electronic device and sending the appropriate and necessary information to the event holder.

Today'subiquitous personal electronic devices, like smart phones, PDAs, tablets, Ipads, etc, all have internal databases with pre-entered pertinent details of the device owner. These details typically include name, address, e mail, phone number etc.

Therefore, instead of the recipient actively registering for the event, registration for the event occurs automatically once he makes some indication that he wants to attend. When that indication is made, such as by touching a registration icon on his smart phone, the electronic device automatically uploads preselected information about recipient from that internal database and sends it via the Internet to the event holder.

Registration for the event, therefore, comprises automatically uploading preselected information about the recipient from a personal electronic device of the recipient and sending it via said Internet to a event holder.

Another aspect of registration may include completion of a form. These forms may be laid out in a special manner with fields arranged in a known manner. Thus, scanners can read the data quickly and enter it directly into the file of the registrant without human involvement, provided data is entered in the correct field.

When this registration form is received, the recipient's personal electronic device can pull the relevant data from its internal database, such as name, membership number etc, and enter that information in the correct fields on the form. Registration is completed by the electronic return of the form to the event holder. This can now occur without active involvement of the registrant.

Registration for the event, therefore, may also comprise automatically completing a form from the event holder with preselected information about the recipient from the personal electronic device of the recipient; and, automatically returning the form to the event holder.

One additional aspect is that a person after registering may want to alert people that he will be at that event. Here too that can now be automatic. Once the recipient indicates that he will attend the event, automatically without his active involvement an electronic notice is sent to pre-designated persons.

Therefore, registration further comprises automatically sending an electronic notice to pre-designated people that the recipient will be attending said event.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. (canceled)

2. (canceled)

3. (canceled)

4. A method according to claim 11, wherein said package of said recipient data includes a specific time and day to attend said event, and it is automatically entered on said electronic calendar of said recipient.

5. (canceled)

6. A method according to claim 4, wherein said preselected package of recipient data is provided by uploading from a personal electronic device of said recipient and sending it via Internet to said at least one party correlating event data.

7. (canceled)

8. A method according to claim 6, wherein said response further comprising: automatically sending an electronic notice to pre-designated people that said recipient will be attending said event.

9. A method according to claim 11, wherein said dates, times and locations of said event are inserted on said electronic calendars of said recipients in a manner which does not interfere with scheduling other activities.

10. A method according to claim 9, wherein a listing of said event on said electronic calendar includes a number of days left for the event.

11. An electronic method of alerting recipients, via internet, of an event, said electronic method comprising the steps of:
a) initiating said electronic method to automatically send at least one electronic communication to at least one preselected group of recipients;
b) receiving of said at least one electronic communication by at least one of said recipients of said at least one preselected group, and automatically inserting selected event data onto at least one electronic calendar of said at least one recipient without active involvement by said recipients;
c) responsive to detection of said selected event data in at least one said electronic calendar, initiating a response by at least one said recipient responding to said selected event data written on at least one said electronic calendar from said electronic communication; and,
d) wherein, said response comprises automatically transmitting, via internet, a preselected package of data regarding said at least one said recipient to at least one party engaged in correlating data for said event; wherein,
said receipt of said preselected package of said recipient data by said party correlating event data constitutes at least data necessary to automatically complete a registration form generated by said party correlating data for said event.

12. The method of claim 11, wherein an electronic communication includes any of data related to said event and data not related to said event.

13. The method of claim 12, wherein said data related to said event in said electronic communication includes data necessary to provide payment for said event.

14. The method of claim 13, wherein said response includes payment data from said recipient to effect payment for said event.

15. The electronic method of claim 14, wherein said electronic communication includes additional data related to said event.
